(19) United States
(12) Patent Application Publication
(10) Pub. No.: US 2026/0027624 A1
(43) Pub. Date: Jan. 29, 2026

(54) MULTIPLE-PIECE TOOL HOLDER REDUCER SLEEVES

(71) Applicant: Kennametal Inc., Latrobe, PA (US)

(72) Inventors: Alan Bookheimer, Greensburg, PA (US); Santhosha Boregowda, Bangalore (IN); Ravi Halasur, Shakunavalli (IN); Josef Herud, Fuerth (DE); Alexander Kroedel, Fuerth (DE)

(21) Appl. No.: 19/282,185

(22) Filed: Jul. 28, 2025

(30) Foreign Application Priority Data
Jul. 29, 2024 (IN) 202441057508

(51) Int. Cl. B23B 27/10

(52) U.S. Cl. CPC B23B 27/10

(57) ABSTRACT

Multiple-piece reducer sleeves for receiving tool shanks are disclosed. The reducer sleeves include a generally cylindrical sleeve body defining a longitudinal axis and a separately formed front coolant disk cap. The front coolant disk cap extends axially forward from the sleeve body along the longitudinal axis, and extends radially outward from an inner surface of the sleeve body. The front coolant disk cap includes at least one coolant discharge nozzle that directs coolant fluid in a desired flow pattern during operation of the tools. The multiple-piece designs of the reducer sleeves may minimize manufacturing costs while providing favorable operating characteristics during machining operations.

### RELATED APPLICATION DATA

The present application claims priority pursuant to 35 U.S.C. 119 (a) to Indian Patent Application number 202441057508 filed Jul. 29, 2024, which is incorporated herein by reference in its entirety.

### FIELD OF THE INVENTION

The present invention relates to tool holder reducer sleeves, and more particularly relates to multiple-piece reducer sleeves with thru coolant channels.

### BACKGROUND INFORMATION

Toolholders are used to hold cutting tools such as end mills and drills. In order to cool the inserted cutting tool during operations, the toolholder can include structures with which coolant fluid is transported to the cutting tool. The structures can be coolant lines formed in the toolholder and having respective discharge nozzles or outlet ports on a front face that are aligned with the cutting end of the cutting tool. In the operation, the coolant fluid exits via the discharge nozzles and contacts the cutting tool so that it is cooled during operation.

The provision of thru coolant channels in tool holder reducer sleeves provides advantages in machining operations, for example, in end milling operations such as pocket milling, slot milling, contour milling and the like where metal removal rates may be relatively high. Use of thru coolant channels may improve chip evacuation and heat dissipation for good surface finish and long tool life. In addition, having coolant channel exits that counter centrifugal effects on the coolant streams and cover complete lengths of cutting edges adjacent to the exit streams are also desirable.

### SUMMARY OF THE INVENTION

The present invention provides multiple-piece reducer sleeves for receiving tool shanks. The reducer sleeves include a generally cylindrical sleeve body defining a longitudinal axis and a separately formed front coolant disk cap. The front coolant disk cap extends axially forward from the sleeve body along the longitudinal axis, and extends radially outward from an inner surface of the sleeve body. The front coolant disk cap includes coolant channels with coolant outlet ports that direct coolant fluid in a desired flow pattern during operation of the tools. The multiple-piece designs of the reducer sleeves may minimize manufacturing costs while providing favorable operating characteristics during machining operations.

An aspect of the present invention is to provide a multiple-piece reducer sleeve for receiving a tool shank. The reducer sleeve comprises a generally cylindrical sleeve body defining a longitudinal axis, a front coolant disk cap extending axially forward from the sleeve body along the longitudinal axis and extending radially outward from an inner surface of the sleeve body, and at least one coolant discharge nozzle extending through the front coolant disk cap to at least one coolant outlet port on a front face of the front coolant disk cap. The sleeve body and the front coolant disk cap comprise an assembly of separately formed pieces. A method of making such a multiple-piece reducer sleeve is also provided.

Another aspect of the present invention is to provide a front coolant disk cap for a multiple-piece reducer sleeve that receives a tool shank. The front coolant disk cap comprises a front face comprising at least one coolant outlet port structured and arranged to direct coolant fluid toward a tool, a rear portion structured and arranged for attachment to a sleeve body, and at least one coolant discharge nozzle extending from adjacent the rear portion of the front coolant disk cap to the at least one coolant outlet port. A method of making such a front coolant disk cap is also provided.

A further aspect of the present invention is to provide a rotatable cutting tool assembly comprising a chuck, and a multiple-piece reducer sleeve insertable in the chuck for receiving a tool shank. The multiple-piece reducer sleeve comprises a generally cylindrical sleeve body defining a longitudinal axis, a front coolant disk cap extending axially forward from the sleeve body along the longitudinal axis and extending radially outward from an inner surface of the sleeve body, and at least one coolant discharge nozzle extending through the front coolant disk cap to at least one coolant outlet port on a front face of the front coolant disk cap. The sleeve body and the front coolant disk cap comprise an assembly of separately formed pieces.

These and other aspects of the present invention will be more apparent from the following description.

### BRIEF DESCRIPTION OF THE DRAWINGS

FIG. 1 is an isometric view of a multiple-piece tool holder reducer sleeve.

FIG. 2 is an isometric view of the sleeve body of the multiple-piece reducer sleeve of FIG. 1.

FIG. 3 is an isometric view of a front coolant disk cap of the multiple-piece reducer sleeve of FIG. 1.

FIG. 4 is a front view of the multiple-piece reducer sleeve of FIG. 1.

FIG. 5 is a rear view of the multiple-piece reducer sleeve of FIG. 1.

FIG. 6 is a side sectional view of the multiple-piece reducer sleeve taken through line 6-6 of FIG. 4.

FIG. 7 is a magnified view of a portion of FIG. 6.

FIG. 8 is a front view of the front coolant disk cap of FIG. 3.

FIG. 9 is a rear view of the front coolant disk cap of FIG. 3.

FIG. 10 is a side sectional view of the front coolant disk cap taken through line 10-10 of FIG. 8.

FIG. 11 is a magnified view of a portion of FIG. 10.

FIG. 12 is a side sectional view of the front coolant disk cap taken through line 12-12 of FIG. 8.

FIG. 13 is a magnified view of a portion of FIG. 12.

FIG. 14 is an isometric view of another multiple-piece tool holder reducer sleeve.

FIG. 15 is an isometric view of the sleeve body of the multiple-piece reducer sleeve of FIG. 14.

FIG. 16 is an isometric view of the front coolant disk cap of the multiple-piece reducer sleeve of FIG. 14.

FIG. 17 is a front view of the multiple-piece reducer sleeve of FIG. 14.

FIG. 18 is a side sectional view of the multiple-piece reducer sleeve taken through line 18-18 of FIG. 17.

FIG. 19 is a magnified view of a portion of FIG. 18.

FIG. 20 is a front view of the front coolant disk cap of FIG. 16.

FIG. 21 is a rear view of the front coolant disk cap of FIG. 16.

FIG. 22 is a side sectional view of the front coolant disk cap taken through line 22-22 of FIG. 20.

FIG. 23 is a magnified view of a portion of FIG. 22.

FIG. 24 is a front view of the cylindrical sleeve body of FIG. 15.

FIG. 25 is a side sectional view of the sleeve body taken through line 25-25 of FIG. 24.

FIG. 26 is a magnified view of a portion of FIG. 25.

FIG. 27 is an isometric view of another multiple-piece tool holder reducer sleeve.

FIG. 28 is an isometric view of the cylindrical sleeve body of the multiple-piece reducer sleeve of FIG. 27.

FIG. 29 is an isometric view of the front coolant disk cap of the multiple-piece reducer sleeve of FIG. 27.

FIG. 30 is a front view of the multiple-piece reducer sleeve of FIG. 27.

FIG. 31 is a side sectional view of the multiple-piece reducer sleeve of FIG. 27 taken through line 31-31 of FIG. 30.

FIG. 32 is a magnified view of a portion of FIG. 31.

FIG. 33 is an isometric view of another multiple-piece tool holder reducer sleeve.

FIG. 34 is an isometric view of a sleeve body of the multiple-piece reducer sleeve of FIG. 31.

FIG. 35 is an isometric view of the front coolant disk cap of the multiple-piece reducer sleeve of FIG. 33.

FIG. 36 is a front view of the multiple-piece reducer sleeve of FIG. 33.

FIG. 37 is a side sectional view of the multiple-piece reducer sleeve of FIG. 33 taken through line 37-37 of FIG. 36.

FIG. 38 is a magnified view of a portion of FIG. 37.

FIG. 39 is an isometric view of another multiple-piece tool holder reducer sleeve.

FIG. 40 is an isometric view of the cylindrical sleeve body of the multiple-piece reducer sleeve of FIG. 39.

FIG. 41 is an isometric view of the front coolant disk cap of the multiple-piece reducer sleeve of FIG. 39.

FIG. 42 is a front view of the multiple-piece reducer sleeve of FIG. 39.

FIG. 43 is a rear view of the multiple-piece reducer sleeve of FIG. 39.

FIG. 44 is a side sectional view of the multiple-piece reducer sleeve of FIG. 39 taken through line 44-44 of FIG. 42.

FIG. 45 is a magnified view of a portion of FIG. 44.

FIG. 46 is a front view of the cylindrical sleeve body of FIG. 40.

FIG. 47 is a rear view of the front coolant disk cap of FIG. 41.

### DETAILED DESCRIPTION

The present multi-piece tool holder reducer sleeves are made from separate sleeve body and front coolant disk cap components. The sleeve body may be a generally cylindrical sleeve with a number of slots selected to help with collapsibility. The front coolant disk cap may comprise an annular disk with coolant channels including discharge nozzles with outlet ports structured and arranged to counter centrifugal effects and to adequately cover the length of the cutting tool. The sleeve body and front coolant disk cap may be manufactured by selected manufacturing methods. For example, additive manufacturing may be used to produce the front coolant disk cap with coolant channels including the discharge nozzles and outlet ports, while the sleeve body may be produced by conventional machining techniques. The separately formed pieces may be joined as one-piece that works favorably in machining applications. Suitable joining methods include brazing, friction brazing, welding, adhesives, hybrid 3D printing, threading, press fitting, shrink fitting, mechanical profile locking, mechanical fasteners and the like.

The sleeve body comprises at least one coolant supply channel running along the length of the body, e.g., parallel with the central longitudinal axis of the body. At least one discharge nozzle with an outlet port is formed in the front coolant disk cap, and is fluidly connected to the coolant supply channel such that coolant fluid can be ejected onto a tool held in the tool holder reducer sleeve. The discharge nozzles may be inclined in order to generate coolant flow that is aligned and accelerated, for example, to counteract the centrifugal forces that occur during rotation of the cutting tools.

According to one embodiment, multiple discharge nozzles and outlet ports are distributed in the circumferential direction around the front cap and may be inclined radially inward and/or inclined in the circumferential direction. At least one discharge nozzle may have a different inclination in the radial direction and/or in the circumferential direction than the other discharge nozzles. The inclination angles of individual discharge nozzles may be selected for certain operating states, e.g., for certain speeds or fluid pressures. The discharge nozzles may thus be structured and arranged for different operating conditions. Each discharge nozzle may taper toward its outlet port to increase the flow rate of the coolant, which may be advantageous in terms of the discharge behavior of the coolant out of the discharge nozzle.

The at least one coolant supply channel may extend at least in sections inside the sleeve body, or may be configured at least in sections as a groove that extends on an outer surface of the sleeve body, or may be configured at least in sections as a slot that extends radially through the sidewall of the sleeve body. In the first case, the coolant supply channel(s) may be embedded or enclosed at least in sections in the sleeve body. In the second case, the coolant supply channel may be radially open at least in sections and is completed or closed by an associated inner wall of the toolholder in which the toolholder is held. In the case of a slot, the coolant supply channel may be closed by an associated wall of the toolholder and the inserted cutting tool. Such variants make it possible to reliably introduce coolant into a chipping zone or to conduct it to the chipping zone during cutting operations.

In the case of a slot, an advantage may be that flexibility of the toolholder is increased so that the toolholder can be adjusted in the radial direction. This may be particularly advantageous when the toolholder is an adapting sleeve held in an expansion chuck. As a result, via the expansion chuck and the interposed adapting sleeve, a clamping force can be applied to a cutting tool inserted into the adapting sleeve without damaging the adapting sleeve. Provided that the at least one coolant supply channel extends inside the holding body or is configured as a groove, additional slots can be provided as needed in order to increase the flexibility of the toolholder. A coolant supply channel in the form of a slot may also be advantageous for thin wall thicknesses of the toolholder, for which a closed channel or groove is difficult to manufacture.

The coolant supply channel may comprise a cooling manifold section that distributes coolants to discharge nozzles. At least two discharge nozzles may be associated with each cooling manifold section, for example, when the cooling manifold section extends only over a partial region of the circumference of the sleeve body. With the cooling manifold section, it is thus possible for multiple discharge nozzles to be supplied by a common coolant supply channel. Two, three or more discharge nozzles may be provided per coolant supply channel, which are supplied with coolant via the cooling manifold section. Due to the fact that multiple discharge nozzles may be fluidly connected to a coolant supply channel by means of the cooling manifold section, the number of coolant supply channels required may be reduced, and thus manufacturing costs may be reduced. In this manner, a sufficiently large volumetric flow of coolant can be output via the coolant manifold sections having relatively few cooling channels.

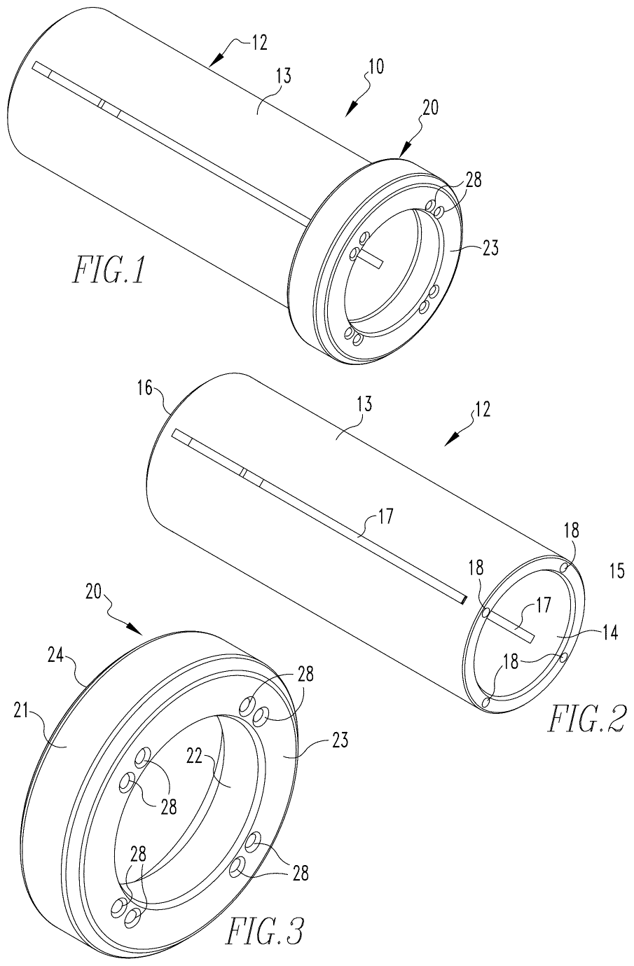

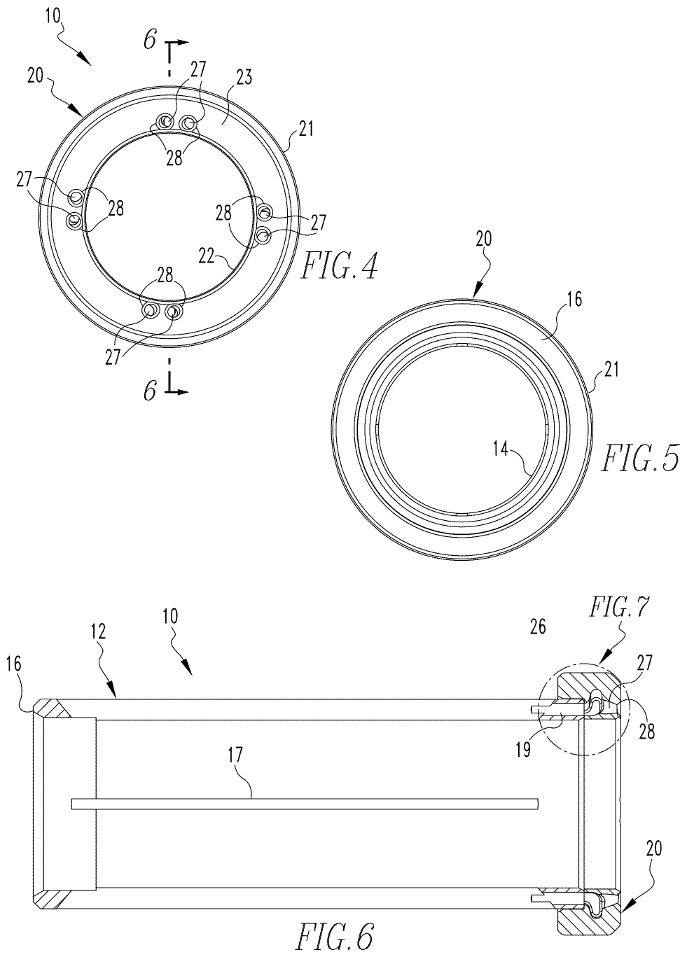

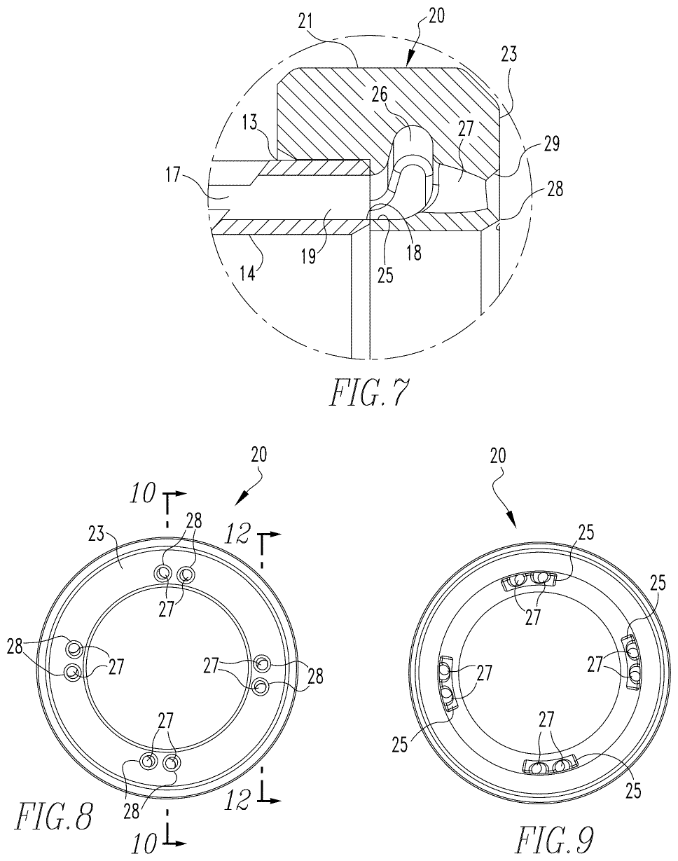

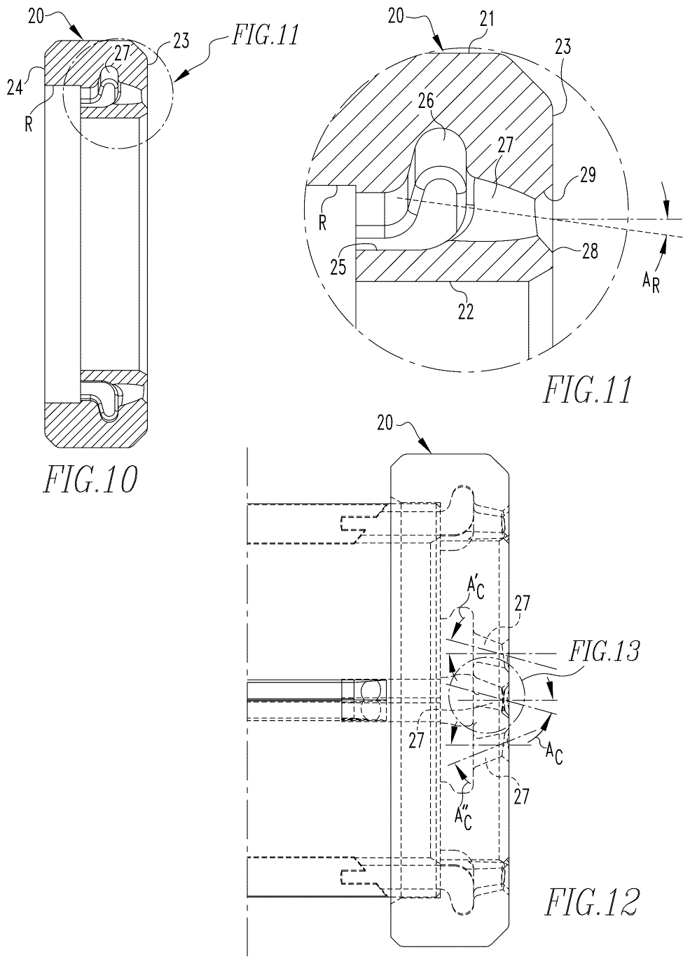

FIGS. 1-13 illustrate a multiple-piece tool holder reducer sleeve 10 including a sleeve body 12 and a separate front coolant disk cap 20 attached to a front end of the sleeve body 12. As shown in FIGS. 1, 2, 5 and 6, the sleeve body 12 includes an outer surface 13, an inner surface 14, a front face 15, and a rear face 16. Coolant channel slots 17 extend along the length of the sleeve body 12. In the embodiment shown, the coolant channel slots 17 extend through the entire wall of the sleeve body 12 from its outer surface 13 to its inner surface 14. As shown in FIGS. 2, 6 and 7, coolant outlet ports 18 are provided through the front face 15 of the sleeve body 12. In the embodiment shown, four coolant channel slots 17 and coolant outlet ports 18 are provided around the circumference of the sleeve body 12 at equally-spaced 90 degree intervals. However, any other suitable number and arrangement of coolant channel slots and outlet ports may be used. As shown most clearly in FIGS. 6 and 7, front coolant channel passages 19 are located toward the front end of the sleeve body 12 between the outer and inner surfaces 13 and 14. Each front coolant channel passage 19 communicates with a corresponding coolant channel slot 17 and coolant outlet port 18.

As shown in FIGS. 1 and 3-9, the front coolant disk cap 20 includes an outer surface 21, an inner surface 22, a front face 23, and a rear face 24. The front coolant disk cap 20 includes a rear annular recess R that receives the front end of the sleeve body 12 when the multiple-piece tool holder reducer sleeve 10 is assembled. Rear coolant inlet slots 25 are provided in the annular recess R, and are aligned with a corresponding front coolant channel passage 19 and coolant outlet port 18 of the sleeve body 12. Each coolant inlet slot 25 communicates with a corresponding coolant manifold 26 located inside the front coolant disk cap 20 between the outer and inner surfaces 21 and 22. At least one coolant discharge nozzle 27 communicates with each of the coolant manifolds 26, and extends forward from the manifold 26 toward the front end of the front coolant disk cap 20. Each coolant discharge nozzle 27 terminates at a coolant outlet port 28 extending through the front face 23 of the front coolant disk cap 20. As more fully described below, each coolant discharge nozzle 27 may include a constricted portion and a downstream flared front portion 29 that extends to the coolant outlet port 28. In the embodiment shown, two coolant discharge nozzles 27 are provided in communication with each coolant manifold 26. However, any other suitable number of coolant discharge nozzles may be used, for example, one, three, or more coolant discharge nozzles 27 for each coolant manifold 26. In the embodiment shown, four coolant manifolds 26 are provided at equally spaced 90 degree intervals around the circumference of the front coolant disk cap 20. However, any other suitable number of manifolds and spacings may be used.

When assembling or additively manufacturing the separate front coolant disk cap 20 on the front end of the sleeve body 12, each coolant inlet slot 25 and accompanying coolant manifold 26 are aligned with a corresponding front coolant channel passage 19 and coolant outlet port 18 of the sleeve body 12. In this manner, during operation of the multiple-piece tool holder reducer sleeve 10, coolant may flow through the coolant channel slots 17 into the front coolant channel passages 19 and then exits the sleeve body 12 through the coolant outlet ports 18, where the coolant passes from the coolant outlet ports 18 into the coolant inlet slots 25 of the front coolant disk cap 20. The coolant then fills or at least partially fills the coolant manifolds 26, and is discharged through the coolant discharge nozzles 27 and through the coolant outlet ports 28 in the front face 23 of the front coolant disk cap 20.

As shown in FIGS. 4 and 6-13, the configuration of each coolant discharge nozzle 27 may be controlled in order to produce desired coolant flow patterns during operation of the multiple-piece tool holder reducer sleeve 10. As most clearly shown in the magnified sectional view of FIG. 11, the coolant discharge nozzle 27 may be directed at a radial discharge angle AR which, in the embodiment shown, is directed radially inward.

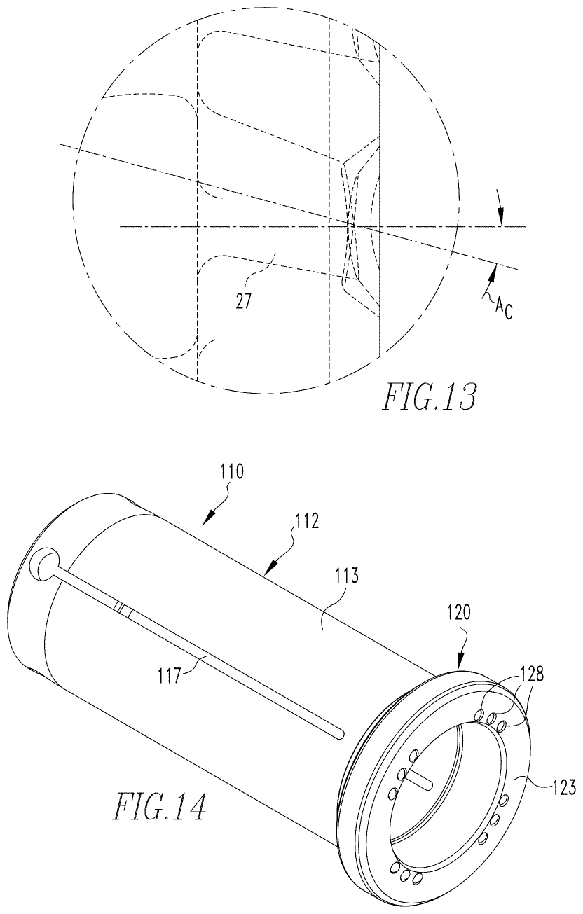

As most clearly shown in FIGS. 12 and 13, each coolant discharge nozzle 27 may be directed at a circumferential discharge angle Ac, Ac′ and Ac “. As more fully described below, the circumferential discharge angles Ac, Ac′ and Ac” may be directed toward or away from the rotational direction of the front coolant disk cap 20 during operation of the multiple-piece tool holder reducer sleeve 10.

The inclination angle of each discharge nozzle in the radial direction AR directs coolant flow radially inward. For example, the inwardly directed radial discharge angle AR may be greater than 1 degree, or greater than 2 degrees, or greater than 3 degrees. For example, the radial discharge angle AR may be between 3 degrees and 30 degrees, or between 6 degrees and 15 degrees. At such angles, the coolant exiting the discharge nozzles at least largely flows along a shaft of a cutting tool inserted in the toolholder up to the cutting edges.

Each of the circumferential discharge angles Ac, Ac′ and Ac″ may be inclined toward or away from the rotational direction of the reducer sleeve, i.e., Ac may be swept forward or swept backward in relation to the rotational direction of the reducer sleeve. The circumferential discharge angles Ac, Ac′ and Ac″ may be greater than +1 degree, or greater than +2 degrees, or greater than +3 degrees, or greater than +5 degrees. For example, the circumferential discharge angles Ac, Ac′ and Ac″ may be between +3 degrees and +45 degrees, or between +6 degrees and +30 degrees, or between +10 and +20 degrees. When the circumferential discharge angle is swept forward toward the rotational direction of the reducer sleeve the angle may be considered positive, and when swept backward away from the rotational direction may be considered negative, for example, Ac may be swept forward, e.g., Ac=+15 degrees, or swept backward, e.g., Ac=−15 degrees.

The radial discharge angle AR and the circumferential discharge angle Ac may be the same or different. For example, at least one of the circumferential discharge angles Ac, Ac′ and Ac″ may be greater than the radial discharge angle AR such that acceleration of the coolant flow counters the centrifugal forces. Tool rotation speeds of between 3,000 and 15,000 revolutions per minute may often be achieved and the coolant fluid may be supplied in a typical pressure range of 10 bar to 80 bar. In this way, a high proportion of coolant may directly strike the cutting tool, so that it is particularly efficiently cooled. Desired cooling may be achieved by controlling flow rate, discharge behavior, flow rigidity and flow pattern of the coolant.

The front coolant disk cap 20 may be produced by any suitable methods including additive manufacturing, machining, metal injection molding, and the like. As understood by those skilled in the art, “additive manufacturing” refers to processes for forming a three-dimensional object by successively adding material to the object layer by layer. The three-dimensional object may be based upon a 3D model of the component object that may be electronically designed as part of an electronic file having the design parameters.

The pre-formed front coolant disk cap 20 may be attached to the sleeve body 12 by any suitable means including brazing, friction brazing, welding, adhesives, press fitting, shrink fitting, threading, mechanical locking, mechanical fasteners such as screws, and the like. Alternatively, the front coolant disk cap 20 may be additively manufactured directly on the pre-formed sleeve body 12, e.g., by a hybrid 3D printing process.

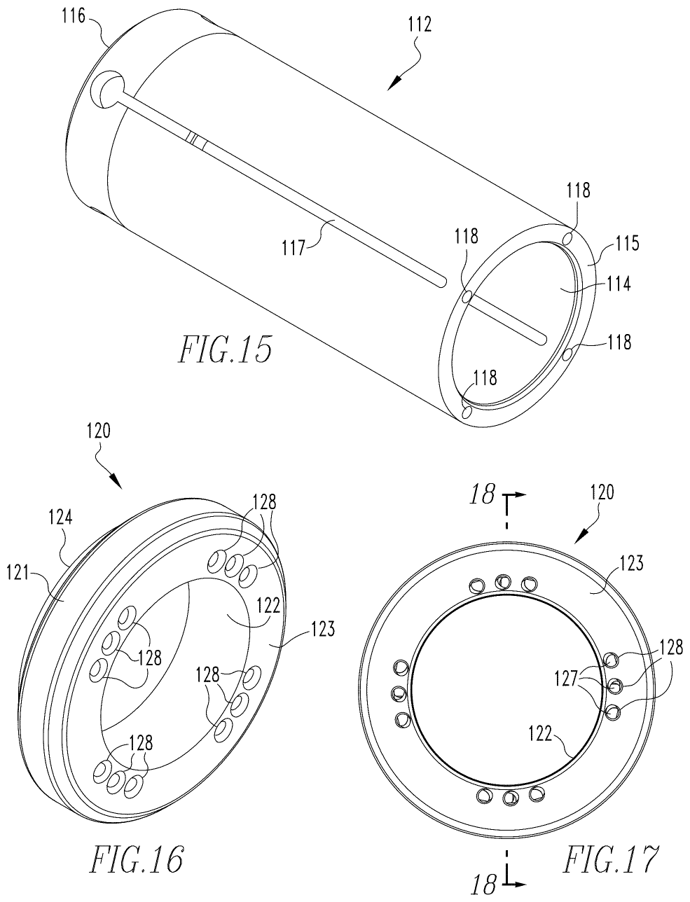

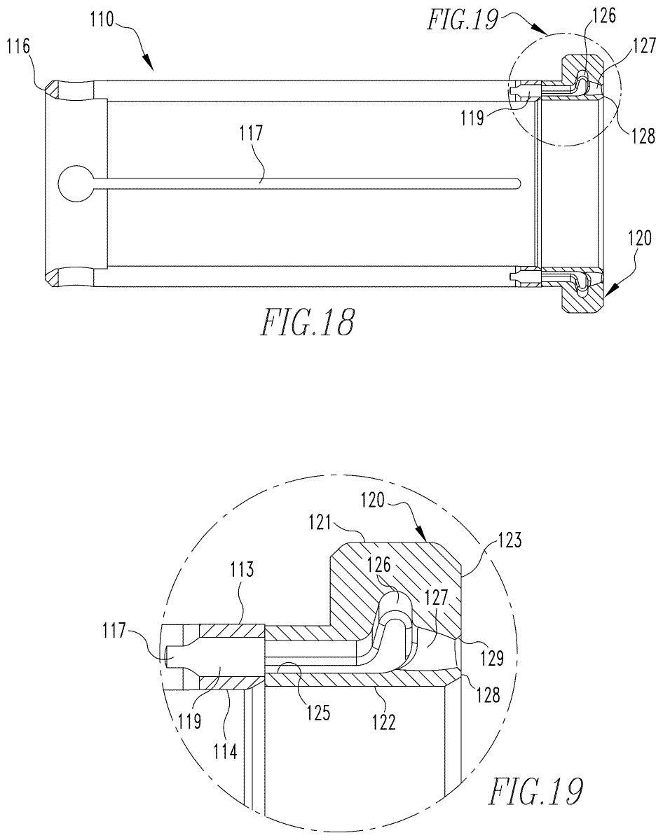

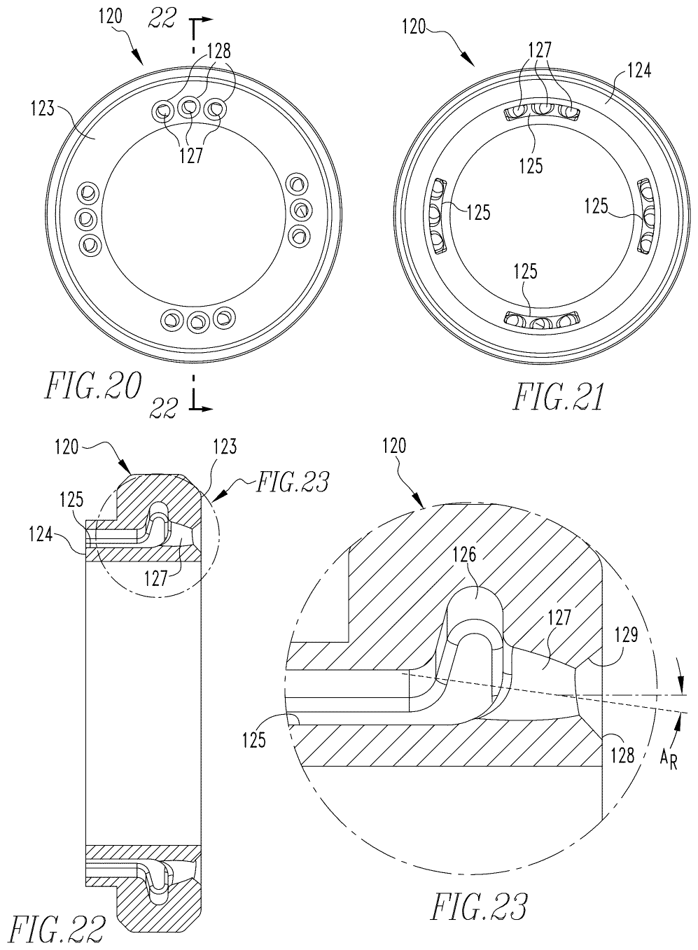

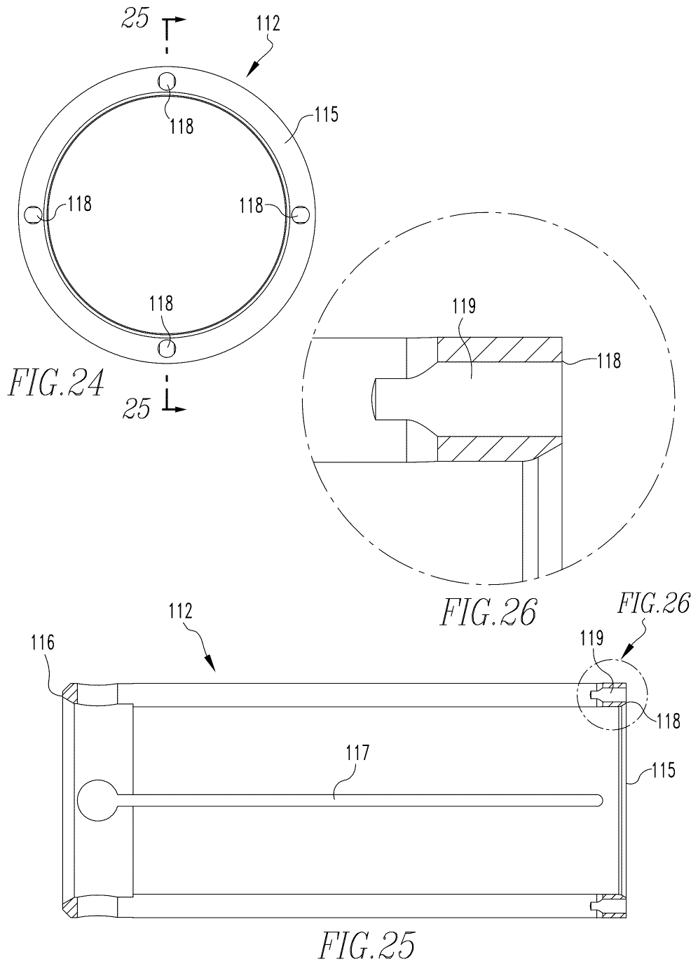

FIGS. 14-26 illustrate another multiple-piece tool holder reducer sleeve 110 including a sleeve body 112 and a separate front coolant disk cap 120 attached to a front end of the sleeve body 112. The sleeve body 112 includes an outer surface 113, an inner surface 114, a front face 115, and a rear face 116. Coolant channel slots 117 extend along the length of the sleeve body 112. In the embodiment shown, the coolant channel slots 117 extend through the entire wall of the sleeve body 112 from its outer surface 113 to its inner surface 114. Coolant outlet ports 118 are provided through the front face 115 of the sleeve body 112. While four coolant channel slots 117 and coolant outlet ports 118 are provided around the circumference of the sleeve body 112 at equally-spaced 90 degree intervals in the embodiment shown, any other suitable number and arrangement of coolant channel slots and outlet ports may be used. Front coolant channel passages 119 are located toward the front end of the sleeve body 112 between the outer and inner surfaces 113 and 114. Each front coolant channel passage 119 communicates with a corresponding coolant channel slot 117 and coolant outlet port 118.

The front coolant disk cap 120 includes an outer surface 121, an inner surface 122, a front face 123, and a rear face 124. Rear coolant inlet slots 125 are provided in the rear face 124, and are aligned with a corresponding front coolant channel passage 119 and coolant outlet port 118 of the sleeve body 112. Each coolant inlet slot 125 communicates with a corresponding coolant manifold 126 located inside the front coolant disk cap 120 between the outer and inner surfaces 121 and 122. At least one coolant discharge nozzle 127 communicates with each of the coolant manifolds 126, and extends forward from the manifold 126 toward the front end of the front coolant disk cap 120. Each coolant discharge nozzle 127 terminates at a coolant outlet port 128 extending through the front face 123 of the front coolant disk cap 120. Each coolant discharge nozzle 127 may include a constricted portion and a downstream flared front portion 129 that extends to the coolant outlet port 128. In the embodiment shown, three coolant discharge nozzles 127 are provided in communication with each coolant manifold 126. However, any other suitable number of coolant discharge nozzles may be used, for example, one, two, four, or more coolant discharge nozzles 127 for each coolant manifold 126. In the embodiment shown, four coolant manifolds 126 are provided at equally spaced 90 degree intervals around the circumference of the front coolant disk cap 120. However, any other suitable number of manifolds and spacings may be used.

When additively manufacturing or assembling the separate front coolant disk cap 120 on the front end of the sleeve body 112, each coolant inlet slot 125 and accompanying coolant manifold 126 are aligned with a corresponding front coolant channel passage 119 and coolant outlet port 118 of the sleeve body 112. In this manner, during operation of the multiple-piece tool holder reducer sleeve 110, coolant may flow through the coolant channel slots 117 into the front coolant channel passages 119 and then exits the sleeve body 112 through the coolant outlet ports 118, where the coolant passes from the coolant outlet ports 118 into the coolant inlet slots 125 of the front coolant disk cap 120. The coolant then fills or at least partially fills the coolant manifolds 126, and is discharged through the coolant discharge nozzles 127 and through the coolant outlet ports 128 in the front face 123 of the front coolant disk cap 120.

As described above, the configuration of each coolant discharge nozzle 127 may be controlled in order to produce desired coolant flow patterns during operation of the multiple-piece tool holder reducer sleeve 110, e.g., by controlling the radial and circumferential discharge angles AR and Ac as described above.

The front coolant disk cap 120 may be produced by any suitable methods such as hybrid additive manufacturing processes in which the disk cap 120 is built up layer-by-layer on the sleeve body 112. In such hybrid processes, the sleeve body 112 acts as a substrate upon which the front coolant disk cap 120 is additively manufactured.

Alternatively, the front coolant disk cap 120 may be pre-formed prior to attachment to the sleeve body 112 by any suitable means including additive manufacturing, machining, metal injection molding, and the like. The pre-formed front coolant disk cap 120 may then be attached to the sleeve body 112 by any suitable means such as brazing, friction brazing, welding, adhesives, mechanical locking, mechanical fasteners, or the like.

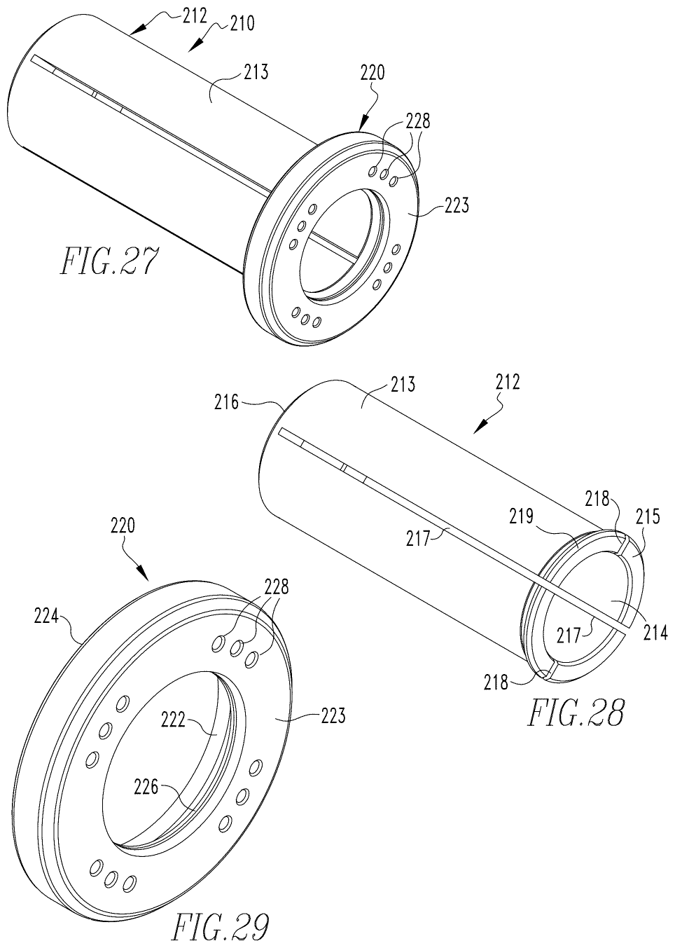

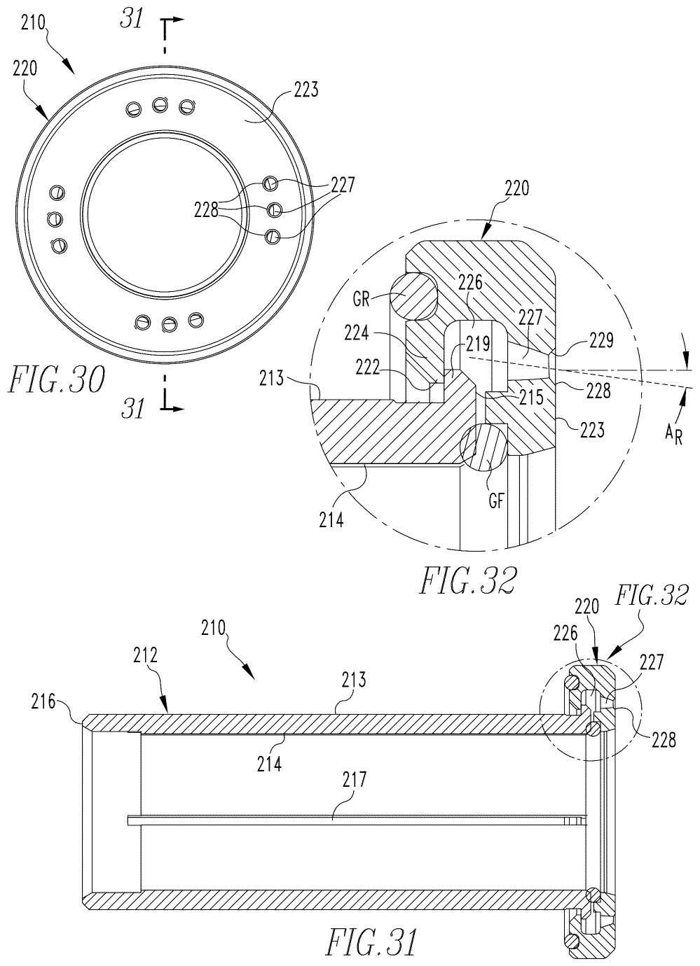

FIGS. 27-32 illustrate another multiple-piece tool holder reducer sleeve 210 including a sleeve body 212 and a separate front coolant disk cap 220 attached to a front end of the sleeve body 212. The sleeve body 212 includes an outer surface 213, an inner surface 214, a front face 215, a rear face 216 and a sectioned front attachment lip 219. Coolant channel slots 217 extend along the length of the sleeve body 212. In the embodiment shown, the coolant channel slots 217 extend through the entire wall of the sleeve body 212 from its outer surface 213 to its inner surface 214. Coolant outlet slots 218 are provided through the front face 215 of the sleeve body 212 to define the front attachment lip sections 219. The attachment lip 219 is thus separated into multiple circumferential sections that are collapsible radially inward during attachment of the front coolant disk cap 220, as more fully described below. In the embodiment shown, four coolant channel slots 217 and coolant outlet slots 218 are provided around the circumference of the sleeve body 212 at equally-spaced 90 degree intervals. However, any other suitable number and arrangement of coolant channel slots and outlet slots may be used.

The front coolant disk cap 220 includes an outer surface 221, an inner surface that forms a retaining lip 222, a front face 223, and a rear attachment collar 224. The front coolant disk cap 220 may be mechanically locked onto the sleeve body 212 through engagement between the attachment lip 219 of the sleeve body and the rear attachment collar 224 of the disk cap, as more fully described below. An annular coolant manifold 226 is located inside the front coolant disk cap 220 adjacent to the rear attachment collar 224. At least one coolant discharge nozzle 227 communicates with the coolant manifold 226, and extends forward from the manifold 226 toward the front end of the front coolant disk cap 220. Each coolant discharge nozzle 227 terminates at a coolant outlet port 228 extending through the front face 223 of the front coolant disk cap 220. Each coolant discharge nozzle 227 may include a constricted portion and a downstream flared front portion 229 that extends to the coolant outlet port 228. In the embodiment shown, four sets of three coolant discharge nozzles 227 are provided in communication with the coolant manifold 226. However, any other suitable number of coolant discharge nozzles may be used. In the embodiment shown, the four sets of discharge nozzles 227 are provided at equally spaced 90 degree intervals around the circumference of the front coolant disk cap 220. However, any other suitable spacings may be used.

As schematically shown in FIGS. 31 and 32, a front gasket ring GF is provided between the front face 215 of the sleeve body 2A12 and the disk cap 220, and a rear gasket ring GR is provided in an annular channel in the rear face of the front coolant disk cap 220 The gasket rings GF and GR may be made of any suitable elastomeric materials such as PTFE, nitrile, neoprene, EPDM, natural rubber, synthetic rubber, Viton fluorocarbon and the like.

When mechanically locking the front coolant disk cap 220 on the front end of the sleeve body 212, the coolant channel slots 217 and coolant outlet slots 218 in the sleeve body 212 are in fluid communication with the coolant manifold 226. In this manner, during operation of the multiple-piece tool holder reducer sleeve 210, coolant may flow through the coolant channel slots 217 into the coolant outlet slots 218 and then exit the sleeve body 212 through the coolant outlet slots 218 into the coolant manifold 226 of the front coolant disk cap 220. The coolant then fills or at least partially fills the coolant manifold 226, and is discharged through the coolant discharge nozzles 227 and through the coolant outlet ports 228 in the front face 223 of the front coolant disk cap 220.

As described above, the configuration of each coolant discharge nozzle 227 may be controlled in order to produce desired coolant flow patterns during operation of the multiple-piece tool holder reducer sleeve 210, e.g., by controlling the radial and circumferential discharge angles AR and Ac as described above.

The front coolant disk cap 220 may be produced by any suitable methods including additive manufacturing, machining, metal injection molding, and the like. Then, the pre-formed front coolant disk cap 220 may be mechanically attached and locked to the sleeve body 212. The coolant channel slots 217 in the sleeve body 212 provide flexibility that enables radial collapsibility of the front attachment lip sections 219. When the front attachment lip sections 219 are pressed axially into the coolant manifold 226, they initially contact the beveled portion of the retaining lip 222, which radially collapses the lip sections 219 until they pass through the retaining lip 222 of the retaining collar 224. The front attachment lip sections 219 then spring back into the position shown in FIGS. 31 and 32 to mechanically lock the front coolant disk cap 220 onto the sleeve body 212.

The gaskets GF and GR may be used to seal the coolant inside the assembly. The front gasket ring GF that seals the cap 220 and sleeve body 212 may be mounted before assembly. In FIGS. 31 and 32, the front gasket ring GF is schematically shown in its original shape, but it is to be understood that, when assembled, the gasket ring GF would be elastically deformed to form a seal between the front face 215 of the sleeve body 212 and a rear face of the front coolant disk cap 220. The rear gasket ring GR may be partially inserted into the annular channel recess in the rear face of the front coolant disk cap 220 at any suitable time during or after the assembly.

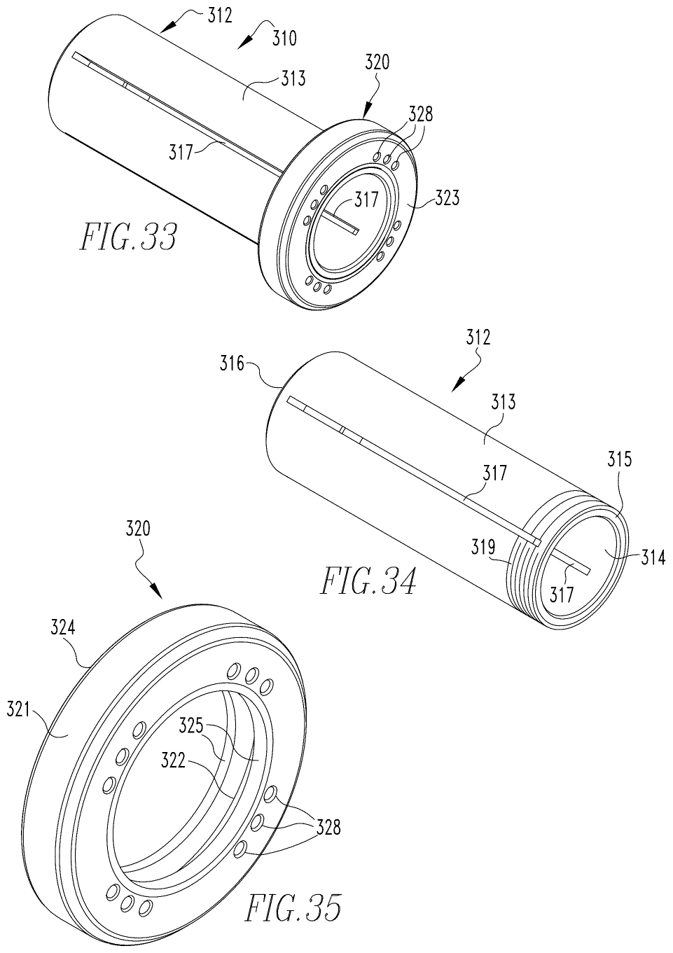

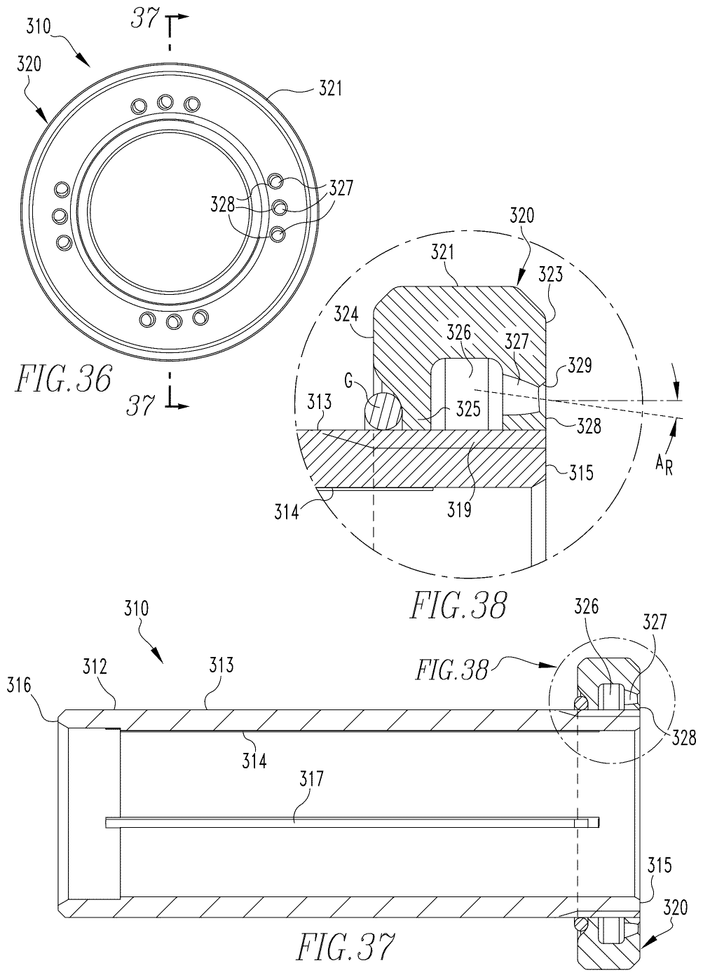

FIGS. 33-38 illustrate another multiple-piece tool holder reducer sleeve 310 including a sleeve body 312 and a separate front coolant disk cap 320 attached to a front end of the sleeve body 312. The sleeve body 312 includes an outer surface 313, an inner surface 314, a front face 315, a rear face 316, and exterior threads 319. Coolant channel slots 317 extend along the length of the sleeve body 312. In the embodiment shown, the coolant channel slots 317 extend through the entire wall of the sleeve body 312 from its outer surface 313 to its inner surface 314. Coolant outlet ports 318 are provided through the front face 315 of the sleeve body 312. As the slots 217 are open and connects the groove 226 in cap 220. Groove 226 is circular groove which connects all the exits/outlet ports 228. In the embodiment shown, four coolant channel slots 17 and coolant outlet ports 318 are provided around the circumference of the sleeve body 312 at equally-spaced 90 degree intervals. However, any other suitable number and arrangement of coolant channel slots and outlet ports may be used.

The front coolant disk cap 320 includes an outer surface 321, an inner surface 322, a front face 323, a rear face 324, and interior threads 325. Coolant manifolds 326 are located inside the front coolant disk cap 320 between the outer and inner surfaces 321 and 322. At least one coolant discharge nozzle 327 communicates with each of the coolant manifolds 326, and extends forward from the manifold 326 toward the front end of the front coolant disk cap 320. Each coolant discharge nozzle 327 terminates at a coolant outlet port 328 extending through the front face 323 of the front coolant disk cap 320. Each coolant discharge nozzle 327 may include a constricted portion and a downstream flared front portion 329 that extends to the coolant outlet port 328. In the embodiment shown, three coolant discharge nozzles 327 are provided in communication with each coolant manifold 326. However, any other suitable number of coolant discharge nozzles may be used. In the embodiment shown, four coolant manifolds 326 are provided at equally spaced 90 degree intervals around the circumference of the front coolant disk cap 320. However, any other suitable number of manifolds and spacings may be used. A gasket ring G may be provided in an annular recess in the rear face 324 of the front coolant disk cap 329.

When threading the separate front coolant disk cap 320 on the front end of the sleeve body 312, each coolant manifold 326 is aligned with a corresponding coolant channel slot 317 of the sleeve body 312. In this manner, during operation of the multiple-piece tool holder reducer sleeve 310, coolant may flow through the coolant channel slots 317 into the coolant outlet ports [318], where the coolant passes into the coolant manifolds 326 of the front coolant disk cap 320. The coolant then fills or at least partially fills the coolant manifolds 326, and is discharged through the coolant discharge nozzles 327 and through the coolant outlet ports 328 in the front face 323 of the front coolant disk cap 320.

As described above, the configuration of each coolant discharge nozzle 327 may be controlled in order to produce desired coolant flow patterns during operation of the multiple-piece tool holder reducer sleeve 310, e.g., by controlling the radial and circumferential discharge angles AR and Ac as described above.

The front coolant disk cap 320 may be produced by any suitable methods including additive manufacturing, machining, metal injection molding, and the like. Then, the pre-formed front coolant disk cap 320 may be attached to the sleeve body 312 by threading the disk cap 320 onto the exterior threads 319 of the sleeve body. The gasket G may be used to scal the coolant inside the assembly.

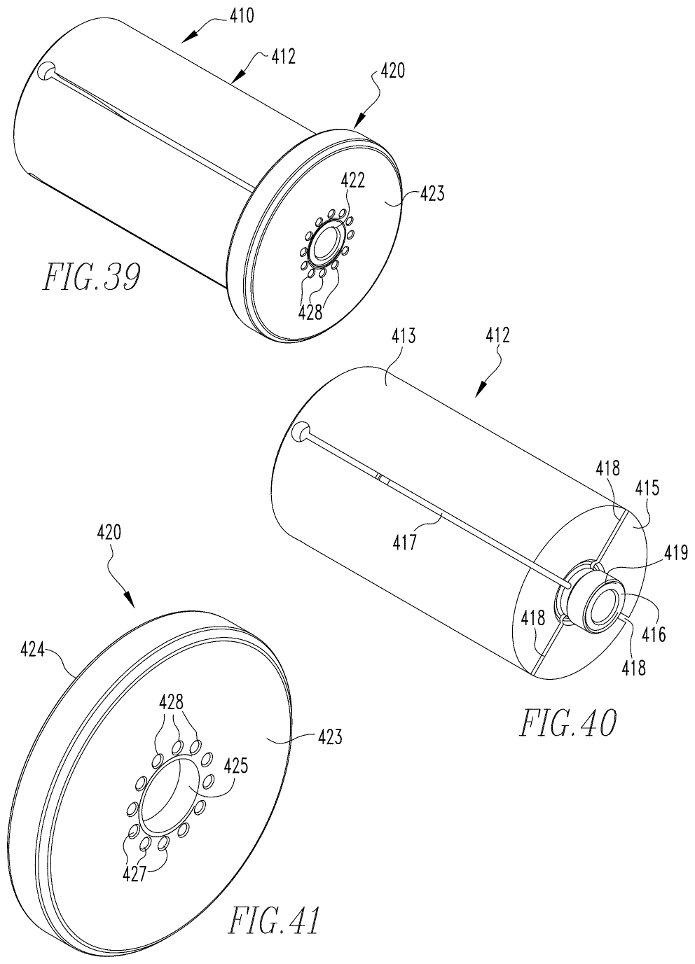

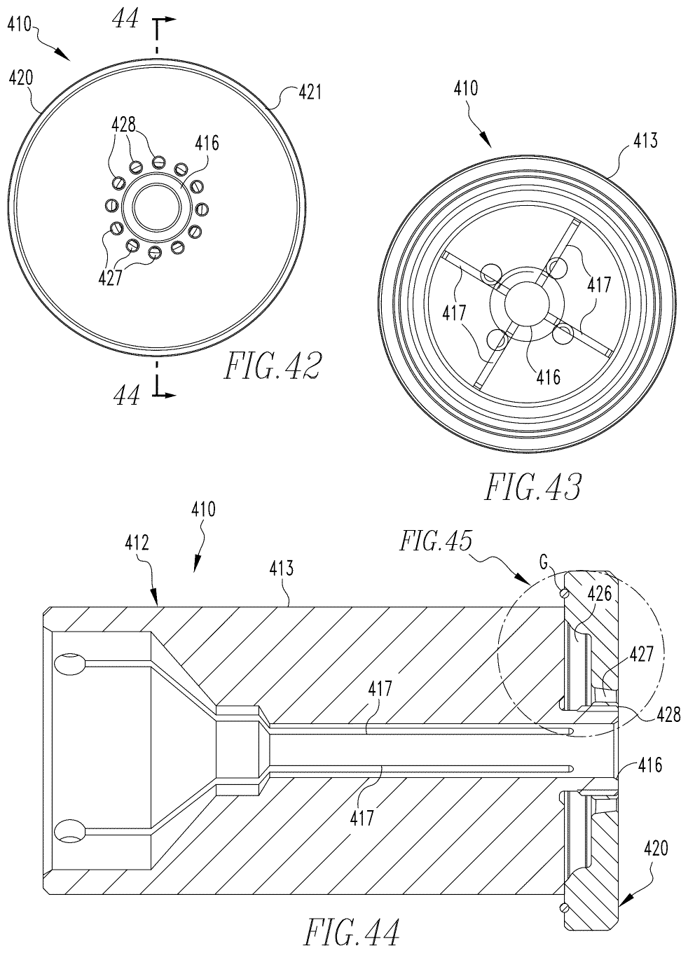

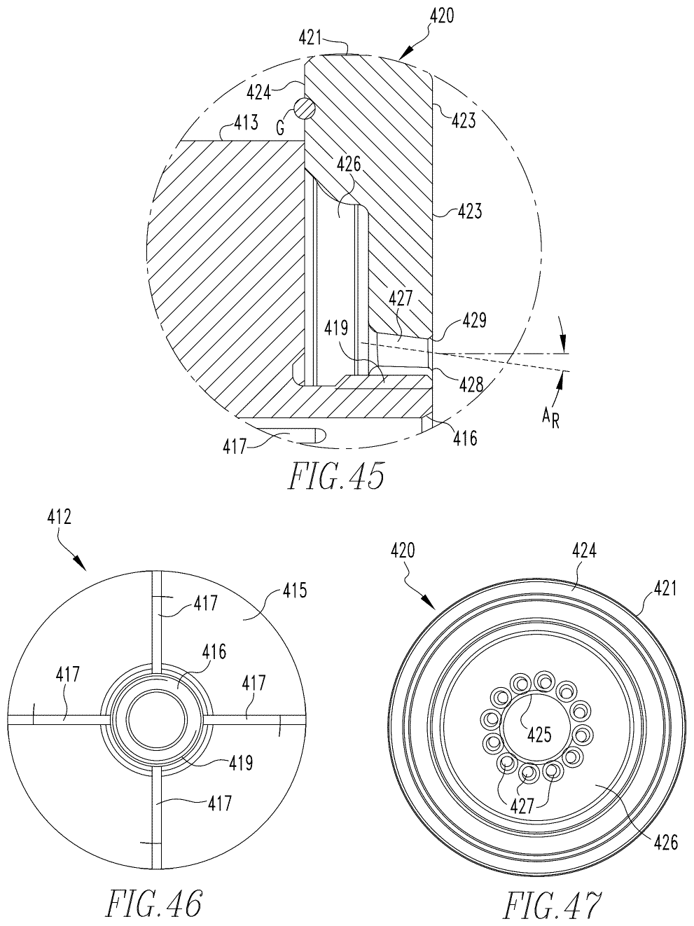

FIGS. 39-47 illustrate another multiple-piece tool holder reducer sleeve 410 including a sleeve body 412 and a separate front coolant disk cap 420 threaded to a front end of the sleeve body 412. The sleeve body 412 includes an outer surface 413, an inner surface 414, a front face 415, a rear face 416, and exterior threads 419. Coolant channel slots 417 extend along the length of the sleeve body 412. In the embodiment shown, the coolant channel slots 417 extend through the entire wall of the sleeve body 412 from its outer surface 413 to its inner surface 414. Coolant outlet slots 418 are provided through the front face 415 of the sleeve body 412. In the embodiment shown, four coolant channel slots 417 and coolant outlet slots 418 are provided around the circumference of the sleeve body 412 at equally-spaced 90 degree intervals. However, any other suitable number and arrangement of coolant channel slots and outlet slots may be used.

The front coolant disk cap 420 includes an outer surface 421, an inner surface 422, a front face 423, a rear face 424, and interior threads 425. A coolant manifold 426 is provided in the rear face 424 of the front coolant disk cap 420. Multiple coolant discharge nozzles 427 communicate with the coolant manifold 426, and extends forward from the manifold 426 toward the front end of the front coolant disk cap 420. Each coolant discharge nozzle 427 terminates at a coolant outlet port 428 extending through the front face 423 of the front coolant disk cap 420. Each coolant discharge nozzle 427 may include a constricted portion and a downstream flared front portion 429 that extends to the coolant outlet port 428. In the embodiment shown, multiple coolant discharge nozzles 427 are equally spaced around the circumference of the front coolant disk cap 420. A gasket ring G may be provided in an annular recess in the rear face 324 of the front coolant disk cap 320.

When threading the separate front coolant disk cap 420 on the front end of the sleeve body 412, the coolant manifold 426 communicates with the coolant outlet slots 418 of the sleeve body 412. In this manner, during operation of the multiple-piece tool holder reducer sleeve 410, coolant may flow through the coolant channel slots 417 into the coolant outlet slots 418 and then exits the sleeve body 412 into the coolant manifold 426, and is then discharged through the coolant discharge nozzles 427 and through the coolant outlet ports 428 in the front face 423 of the front coolant disk cap 420.

As described above, the configuration of each coolant discharge nozzle 427 may be controlled in order to produce desired coolant flow patterns during operation of the multiple-piece tool holder reducer sleeve 410, e.g., by controlling the radial and circumferential discharge angles AR and Ac as described above.

The front coolant disk cap 420 may be produced by any suitable methods including additive manufacturing, machining, metal injection molding, and the like. Then, the pre-formed front coolant disk cap 420 may be threaded to the sleeve body 412 by threading the disk cap 420 onto the sleeve body 412.

As used herein, “including,” “containing” and like terms are understood in the context of this application to be synonymous with “comprising” and are therefore open-ended and do not exclude the presence of additional undescribed or unrecited elements, materials, phases or method steps. As used herein, “consisting of” is understood in the context of this application to exclude the presence of any unspecified element, material, phase or method step. As used herein, “consisting essentially of” is understood in the context of this application to include the specified elements, materials, phases, or method steps, where applicable, and to also include any unspecified elements, materials, phases, or method steps that do not materially affect the basic or novel characteristics of the invention.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances. In this application and the appended claims, the articles “a,” “an,” and “the” include plural referents unless expressly and unequivocally limited to one referent.

Whereas particular embodiments of this invention have been described above for purposes of illustration, it will be evident to those skilled in the art that numerous variations of the details of the present invention may be made without departing from the invention as defined in the appended claims.

What is claimed is:

1. A multiple-piece reducer sleeve for receiving a tool shank, the reducer sleeve comprising:
a generally cylindrical sleeve body defining a longitudinal axis;
a front coolant disk cap extending axially forward from the sleeve body along the longitudinal axis and extending radially outward from an inner surface of the sleeve body; and
at least one coolant discharge nozzle extending through the front coolant disk cap to at least one coolant outlet port on a front face of the front coolant disk cap, wherein the sleeve body and the front coolant disk cap comprise an assembly of separately formed pieces.

2. The multiple-piece reducer sleeve of claim 1, wherein the front coolant disk cap is attached to the sleeve body by brazing, friction brazing, welding, adhesives, press fitting, shrink fitting, threading, mechanical locking, mechanical fasteners, or a combination thereof.

3. The multiple-piece reducer sleeve of claim 1, wherein the front coolant disk cap is additively manufactured, machined, metal injection molded, or a combination thereof.

4. The multiple-piece reducer sleeve of claim 1, wherein the front coolant disk cap is additively manufactured and is formed prior to attachment to the sleeve body.

5. The multiple-piece reducer sleeve of claim 1, wherein the front coolant disk cap is additively manufactured and is applied layer by layer on the sleeve body.

6. The multiple-piece reducer sleeve of claim 1, wherein the front coolant disk cap is mechanically attached to the sleeve body.

7. The multiple-piece reducer sleeve of claim 6, wherein a front end of the sleeve body comprises a front attachment lip comprising a plurality of radially movable front attachment lip sections, the front coolant disk cap comprises a rear attachment collar comprising a retaining lip, and the front attachment lip sections are inserted into the rear attachment collar and engage the retaining lip to thereby mechanically fasten the front coolant disk cap on the sleeve body.

8. The multiple-piece reducer sleeve of claim 7, wherein the sleeve body comprises a plurality of coolant channel slots extending along a length thereof separating adjacent ones of the front attachment lip sections from each other, wherein each of the coolant channel slots is in fluid communication with at least one of the coolant discharge nozzles of the front coolant disk cap.

9. The multiple-piece reducer sleeve of claim 8, further comprising at least one coolant manifold in the front disk cap in fluid communication between the coolant channel slots and the coolant discharge nozzles.

10. The multiple-piece reducer sleeve of claim 1, wherein the front coolant disk cap is threaded onto the sleeve body.

11. The multiple-piece reducer sleeve of claim 10, wherein a front portion of the sleeve body comprises exterior threads, and a rear portion of the front coolant disk cap comprises interior threads threadingly engaged with the exterior threads of the sleeve body.

12. The multiple-piece reducer sleeve of claim 1, comprising at least one coolant channel slot extending along a length of the sleeve body in fluid communication with the at least one coolant discharge nozzle of the front disk cap.

13. The multiple-piece reducer sleeve of claim 12, comprising at least one coolant manifold in the front coolant disk cap in fluid communication between the at least one coolant channel slot and a plurality of the coolant discharge nozzles.

14. The multiple-piece reducer sleeve of claim 1, further comprising a fluid sealing member between the sleeve body and the front coolant disk cap.

15. The multiple-piece reducer sleeve of claim 14, wherein the sealing member comprises an elastic gasket ring adjacent a front end of the sleeve body contacting the front coolant disk cap.

16. The multiple-piece reducer sleeve of claim 1, wherein the at least one coolant discharge nozzle is directed at a radial discharge angle AR measured in relation to the longitudinal axis.

17. The multiple-piece reducer sleeve of claim 16, wherein the radial discharge angle AR is directed radially inward and is greater than 2 degrees.

18. The multiple-piece reducer sleeve of claim 1, wherein the at least one coolant discharge nozzle is directed at a circumferential discharge angle Ac in relation to the longitudinal axis.

19. The multiple-piece reducer sleeve of claim 18, wherein the circumferential discharge angle Ac is directed toward a rotational direction of the front coolant disk cap and is greater than 2 degrees.

20. The multiple-piece reducer sleeve of claim 18, wherein the circumferential discharge angle Ac is directed away from a rotational direction of the front coolant disk cap and is greater than 2 degrees.

21. The multiple-piece reducer sleeve of claim 1, comprising a plurality of the coolant discharge nozzles circumferentially spaced around a circumference of the front coolant disk cap.

22. A method of making the multiple-piece reducer sleeve of claim 1.

23. A front coolant disk cap for a multiple-piece reducer sleeve for receiving a tool shank, the front coolant disk cap comprising:
a front face comprising at least one coolant outlet port structured and arranged to direct coolant fluid toward a tool;
a rear portion structured and arranged for attachment to a sleeve body; and
at least one coolant discharge nozzle extending from adjacent the rear portion of the front coolant disk cap to the at least one coolant outlet port.

24. A method of making the front coolant disk cap of claim 23.

25. A rotatable cutting tool assembly comprising:
a chuck; and
a multiple-piece reducer sleeve insertable in the chuck for receiving a tool shank, the multiple-piece reducer sleeve comprising:
a generally cylindrical sleeve body defining a longitudinal axis;
a front coolant disk cap extending axially forward from the sleeve body along the longitudinal axis and extending radially outward from an inner surface of the sleeve body; and
at least one coolant discharge nozzle extending through the front coolant disk cap to at least one coolant outlet port on a front face of the front coolant disk cap, wherein the sleeve body and the front coolant disk cap comprise an assembly of separately formed pieces.
